(19) United States
(12) Patent Application Publication
(10) Pub. No.: US 2009/0202295 A1
(43) Pub. Date: Aug. 13, 2009

(54) Quick releasing device of actuator

(75) Inventor: Chien-Chih Chen, Taichung (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/069,081

(22) Filed: Feb. 7, 2008

(51) Int. Cl. F16D 1/10

(52) U.S. Cl. 403/325; 403/379.5

(57) ABSTRACT

A quick releasing device of an actuator comprises a quick releasing mechanism deposited on a transmission apparatus and a releasing spring for transmitting a power from the transmission apparatus to a load connector to drive the load connector to linearly move when it is normally constricted or releasing the transmission apparatus to retract the load connector when it is loosened, wherein the releasing spring has a node portion for being pulled to loosen the releasing spring, and a releasing handle settled aside the quick releasing mechanism having a operation portion and a driving portion, wherein, when pulled, the operation portion drives the driving portion to swing toward the node portion so as to pull the node portion and thereby loosen the releasing spring.

### BACKGROUND OF THE INVENTION

1. Technical Field

The present invention relates to actuators, and, more particularly, to a quick releasing device serving to rapidly release an actuator from its working position so that the actuator can automatically return to its initial position.

2. Description of Related Art

Linear actuators are extensively implemented in equipments composed of portions that can be moved with respect to other positions. Taking a hospital bed for example, a linear actuator provided thereto functions as a power source for changing the overall shape of the hospital bed so as to help a person lying on the bad in changing posture. In respective of the above application, while the accurate travel control is an important technical function of such linear actuator, a quick releasing mechanism also provides an indispensable function of returning the actuator to its initial position from a present working position because the hospital bed may have from time to time need to be swiftly returned to a flat position from a bending position for medical staff to offer first aid measures to the patient lying thereon.

Please refer to FIG. 1 for a conventional linear actuator. The linear actuator 900 comprises a driving device 91 for outputting a torque power; a transmission, including a screw shaft 931, a nut 933, and an inner tube 935, wherein the screw shaft 931 is connected with the driving device 91 to transmit the power output by the driving device 91 and the nut 933, when being combined with the screw shaft 931, serves to convert the torque power into a linear motion while the inner tube 935 is fixed on and simultaneously move with the nut 933; a loading connector 95 connected to an external load to drive the same to conduct a linear movement; and a quick releasing device, settled between the transmission and the nut 933 for coaxially connecting the screw shaft 931. The quick releasing device primarily comprises a releasing bushing 951 and a releasing spring 953. Therein, the nut 933 is driven by the releasing bushing 951 and the releasing spring 953 has a node portion 9531 whereby the releasing spring 953 can be loosened from its normal constricted state so as to adjust a constricting force the releasing spring 953 exerting on and the releasing bushing 951 in turn exerting on the screw shaft 931. When the constricting force is sufficient to combine the releasing bushing 951 with the screw shaft 931, the both are combined and transmit the power together to drive the load. Otherwise, the screw shaft 931 is free from the releasing bushing 951 as well as the nut 933 to retract the load. Therefore, by pushing the node portion 9531 of the releasing spring 953, the constricting force the releasing spring 953 acting on the releasing bushing 951 is released, so that the actuator can rapidly return to its initial position.

In the conventional technology, a releasing ring-pull 955 is used to drive a pushing board 957 formed as a right triangle with its hypotenuse adjacent to the node portion 9531. Thereupon, when the releasing ring-pull 955 is pulled outward, the hypotenuse of the pushing board 957 can gradually push the node portion 9531 to horizontally move for a predetermined distance, so as to release the constricting force of the releasing spring 953, thereby returning the actuator to the initial position thereof.

However, the conventional releasing ring-pull 955 has some drawbacks. First, there is a 45-degree angle included between a direction the pushing board 957 pushing the node portion 9531 and another direction a user pulling the releasing ring-pull 955, as shown in FIG. 2. Such included angle undesirably disperses a force the user exerting on the releasing ring-pull 955. Namely, the force exerted by the user cannot fully serve to push the node portion 9531, resulting in waste of force. Besides, since production and installation of the node portion 9531 of the releasing spring 953 rely on manual operation, in manufacturing, it is difficult to uniform the locations of the node portions 9531 in all quick releasing devices. The closer the node portion 9531 and the pushing board 957 are, the farther the distance the pushing board 957 pushes the node portions 9531 for, so as to release the spring better. On the contrary, the farther the node portion 9531 from the pushing board 957 is, the more difficultly the node portion 9531 is pushed, resulting in inferior efficiency of the releasing mechanism. Third, since the releasing ring-pull 955 extends parallelly to the travel of the actuator, when the actuator is arranged below a normal hospital bed, it is difficult for the medical staff to operate the releasing ring-pull 955 with a lateral exerting motion. Moreover, when such actuator with the releasing ring-pull 955 is applied to a patient-lifting device, since the travel of the actuator is set upward, the releasing ring-pull 955 has to be pulled upward and such operation not only is adverse to the gravitational direction but also causes laborious operation. To sum up, the conventional quick releasing device with the releasing ring-pull 955 is inconvenient in use and needs to be improved.

### SUMMARY OF THE INVENTION

The present invention has been accomplished under these circumstances in view and provides a quick releasing device of an actuator. Therein, the actuator comprise a driving device for outputting a torque power; a transmission, including a screw shaft, a nut, and an inner tube, wherein the screw shaft is connected with the driving device to transmit the power and the nut when being combined with the screw shaft serves to convert the torque power into a linear motion while the inner tube is fixed on and simultaneously move with the nut; a loading connector connected to an external load to drive the same to conduct a linear movement; and a quick releasing device, settled between the transmission and the nut for coaxially connecting the screw shaft and primarily comprising a releasing bushing, a releasing spring and a releasing handle, wherein the nut is driven by the releasing bushing and the releasing spring has a node portion for loosening the releasing spring from its normal constricted state so as to adjust a constricting force the releasing spring exerting on the releasing bushing and the releasing bushing in turn exerting on the screw shaft, whereby when the constricting force is sufficient to combine the releasing bushing with the screw shaft, the both are combined and transmit the power together to drive the load; otherwise, the screw shaft is free from the releasing bushing and the nut to retract the load and by pushing the node portion of the releasing spring, the constricting force the releasing spring acting on the releasing bushing is released, so that the actuator can rapidly return to its initial position.

The quick releasing device is characterized by a releasing handle settled aside the quick releasing mechanism having a operation portion and a driving portion, wherein, when rotated, the operation portion drives the driving portion to swing toward the node portion so as to pull the node portion and thereby loosen the releasing spring.

According to one embodiment of the present invention, a torsion spring is provided between the operation portion and the driving portion of the releasing handle.

According to one embodiment of the present invention, a plastic hood covers an exterior of the operation portion of the releasing handle and the plastic hood is marked with a term of “releasing handle” so as to be arrestive.

One objective of the present invention is to provide a quick releasing device of an actuator implement the Principle of Moments to efficiently transmit a user's force to a node portion of a releasing spring so as to promptly release the releasing spring and in turn reposition the actuator.

Another objective of the present invention is to provide a quick releasing device of an actuator that efficiently drive a node portion to loosen a releasing spring even when the node portion is slightly misplaced.

Another objective of the present invention is to provide a quick releasing device of an actuator that has a releasing handle such designed that a user can easily rotate and efficiently operate the same with less effort.

Another objective of the present invention is to provide a quick releasing device of an actuator that has a handle operated by a rotational motion and such arranged that an operational path thereof is free from being obstructed by a hospital bed it attached to.

Yet another objective of the present invention is to provide a quick releasing device of an actuator that has a torsion spring provided between an operation portion and a driving portion of a releasing handle thereof for rapidly repositioning the releasing handle after operation and for preventing the combination between the operation portion and the driving portion from becoming loose after a long-term use by a buffering effect the torsion spring provides therebetween.

Still another objective of the present invention is to provide a quick releasing device of an actuator that has a handle covered by a plastic hood with a bright and attention-getting color that is helpful in an emergency.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a sectional view of a linear actuator equipped with a conventional quick releasing device;

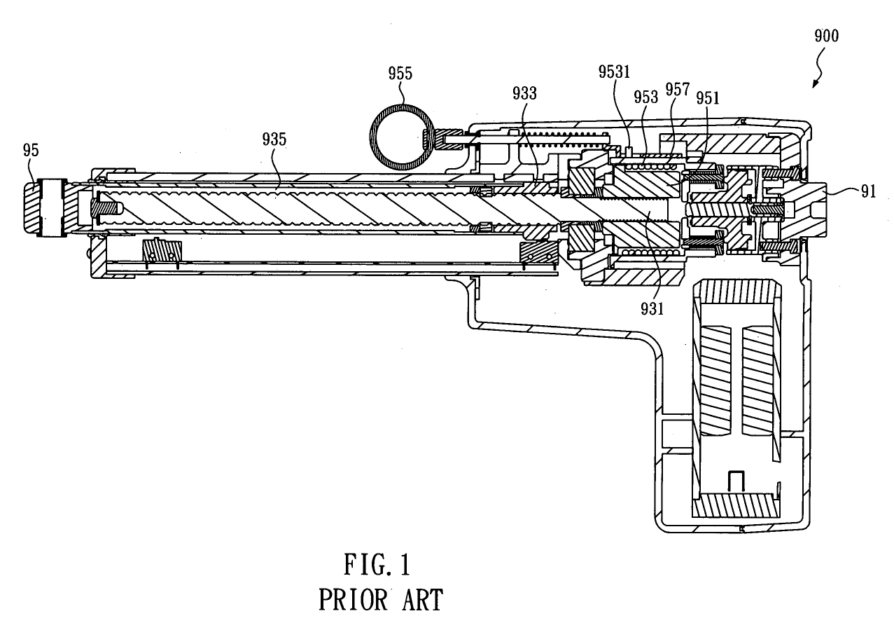

FIG. 2 is a schematic drawing showing the operation of the linear actuator equipped with the conventional quick releasing device;

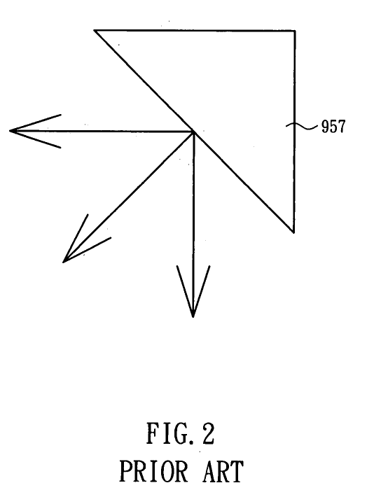

FIG. 3 is a perspective view of a quick releasing device for an actuator of the present invention;

FIG. 4 is a partially enlarged exploded view of the quick releasing device of the present invention;

FIG. 5 is a partially assembled view of the quick releasing device of the present invention;

FIG. 6 is a schematic drawing showing the operation of the linear of the quick releasing device of the present invention; and

FIG. 7 is a perspective view of the quick releasing device showing a hood covered on an operation portion of the quick releasing device.

### DETAILED DESCRIPTION OF THE PREFERRED EMBODIMENT

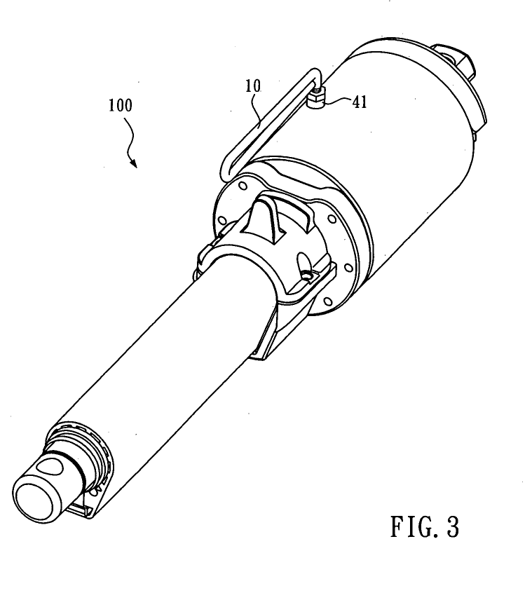

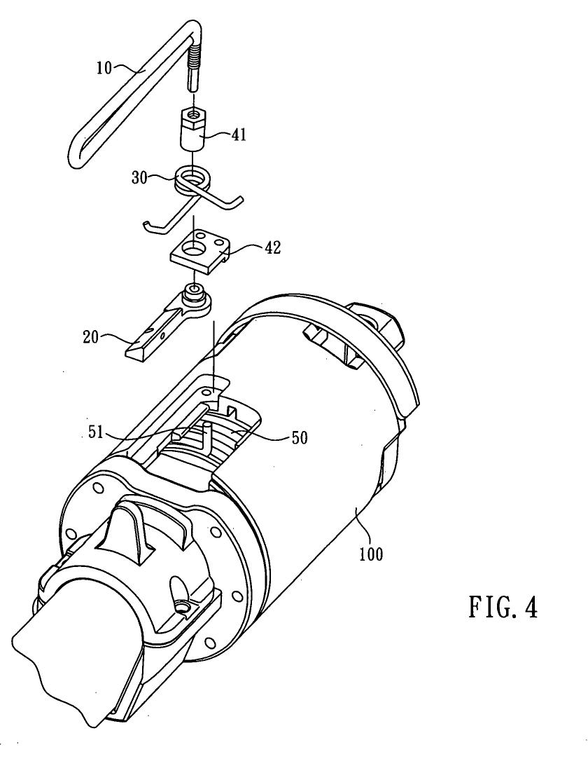

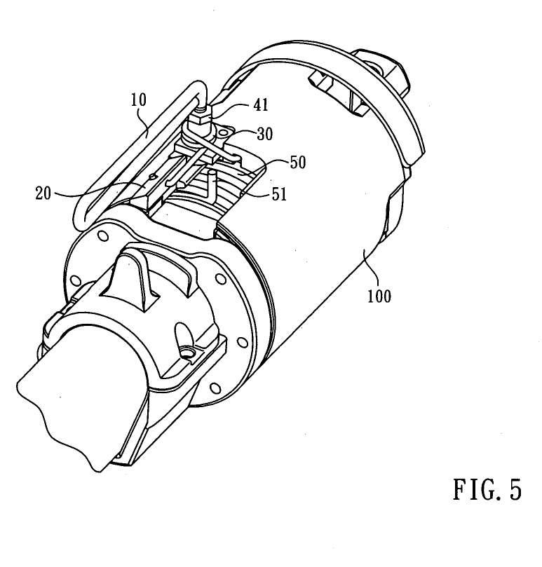

Please refer to FIGS. 3 to 5 for a quick releasing device for an actuator 100. Therein, the actuator 100 is constructed from a driving device and a transmission as those described in the above Description of Related Art, and is not illustrated herein in further detail.

The quick releasing device is characterized by having a releasing handle that is composed of an operation portion 10 and a driving portion 20, wherein when the operation portion 10 is rotate by a user, it drives the driving portion 20 to swing toward a screw shaft of the actuator 100 so as to push a node portion 51 formed on a releasing spring 50. According to one embodiment of the present invention, a torsion spring 30 is provided between the operation portion 10 and the driving portion 30 of the releasing handle for facilitating rapidly repositioning the releasing handle after the rotated releasing handle is released.

According to one embodiment of the present invention, the operation portion 10 and the driving portion 20 are such combined through a fastening nut 41 and a packing 42 that the operation portion and the driving portion are fixedly combined and move synchronously.

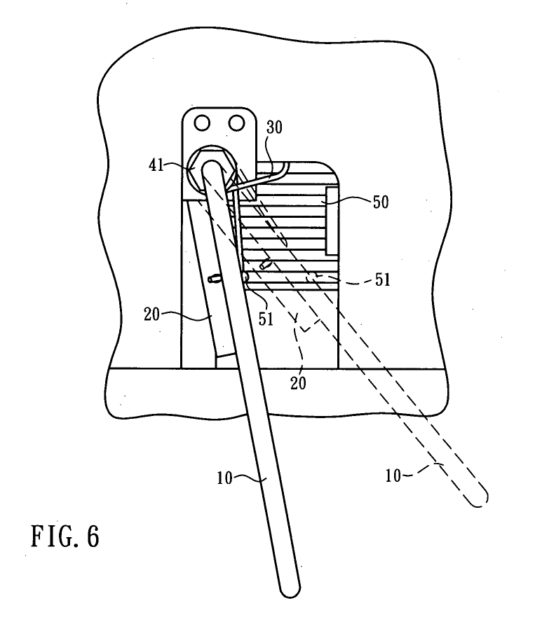

As shown in FIG. 6, the driving portion 20 can efficiently touch and push the node portion 51 despite the distance between the node portion 51 of the releasing spring 50 and the driving portion 20 so as to ensure the effect of loosening the releasing spring 50.

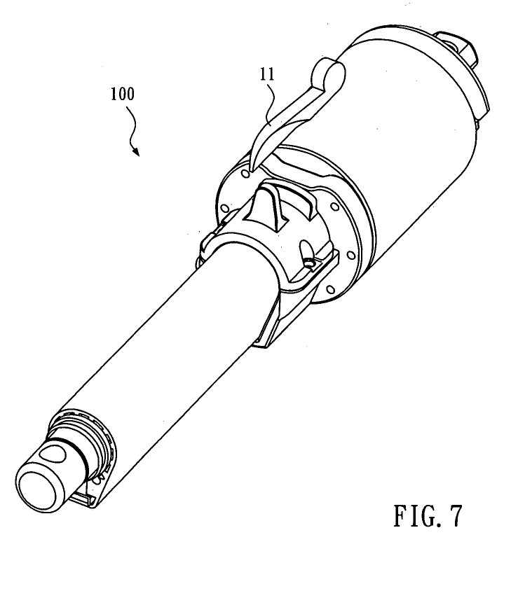

According to one embodiment of the present invention, the operation portion 10 of the releasing handle is covered by a plastic hood 11 with a bright and attention-getting color, as shown in FIG. 7. In addition, the plastic hood 11 may be marked with a catchphrase of “Quick-Releasing Handle” (not shown) so as to attract users' intention.

Through the aforementioned structure, the releasing handle of an actuator has the following advantages:
1. The present invention implements the Principle of Moments to efficiently transmit a user's force to a node portion of a releasing spring so as to promptly release the releasing spring and in turn reposition the actuator.
2. The operation portion of the releasing handle is capable of efficiently driving the node portion even when the node portion is slightly misplaced.
3. The releasing handle is operated by a rotational motion so that a user can easily pull and efficiently operate the same with less effort.
4. The releasing handle is operated by a rotational motion so that the operational path thereof is free from being obstructed by a hospital bed it attached to.
5. Since the torsion spring is provided between an operation portion and a driving portion of a releasing handle thereof, the releasing handle can rapidly reposition after operation and the combination between the operation portion and the driving portion is prevented from becoming loose after a long-term use by the buffering effect the torsion spring provides therebetween.
6. The releasing handle is covered by a plastic hood with a bright and attention-getting color that is helpful in an emergency.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A quick releasing device of an actuator, comprising
a quick releasing mechanism, deposited on a transmission apparatus of the actuator and having a releasing spring for transmitting a power from the transmission apparatus to a load connector to drive the load connector to linearly move when it is normally constricted or releasing the transmission apparatus to retract the load connector when it is loosened, wherein the releasing spring has a node portion for being pulled to loosen the releasing spring, and
a releasing handle settled aside-the quick releasing mechanism having a operation portion and a driving portion, wherein, when pulled, the operation portion drives the driving portion to swing toward the node portion so as to pull the node portion and thereby loosen the releasing spring.

2. The quick releasing device of claim 1, wherein, a torsion spring is provided between the operation portion and the driving portion of the releasing handle.

3. The quick releasing device of claim 1, wherein, the operation portion and the driving portion are such combined through a fastening nut and a packing that the operation portion and the driving portion are fixedly combined and move synchronously.

4. The quick releasing device of claim 1, wherein, a plastic hood covers an exterior of the operation portion of the releasing handle.

5. The quick releasing device of claim 4, wherein, the plastic hood is colored with a bright and attention-getting color.

6. The quick releasing device of claim 4, wherein, the plastic hood is marked with a catchphrase of “Quick-Releasing Handle”.
